(19) United States
(12) Patent Application Publication
(10) Pub. No.: US 2011/0026109 A1
(43) Pub. Date: Feb. 3, 2011

(54) OPTICAL LENS, OPTICAL SYSTEM UNIT AND IMAGING APPARATUS

(75) Inventors: Hiromitsu Yamakawa, Saitama-shi (JP); Hitoshi Miyano, Saitama-shi (JP); Eiichi Suzuki, Saitama-shi (JP); Tatsuhiko Obayashi, Minami-ashigara-shi (JP); Seiichi Watanabe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/673,909

(22) PCT Filed: Aug. 14, 2008
(86) PCT No.: PCT/JP2008/064858

§ 371 Date: Feb. 17, 2010

(30) Foreign Application Priority Data
Aug. 21, 2007 (JP) 2007-215315

(51) Int. Cl. G02B 5/20; G02B 1/04

(52) U.S. Cl. 359/361

(57) ABSTRACT

In a surveillance camera 2, an optical system unit for use in imaging is provided with a first lens 7, a second lens 8, a third lens 9, and a fourth lens 10, and a subject image is formed on a photoelectric surface 12 of an imaging element through a cover glass 11. The third lens 9 is an optical lens made of a nanocomposite material of the invention in which inorganic fine particles are dispersed. A thin film layer 15 that blocks UV rays is formed on a light incident surface of the third lens 9. After passing through the first lens 7 and the second lens 8, UV rays contained in subject light are blocked by the thin film layer 15 and therefore cannot enter the third lens 9.

### TECHNICAL FIELD

The present invention relates to an optical lens made of thermoplastic polymer, an optical system unit including the optical lens, and an imaging apparatus using the optical system unit.

### BACKGROUND ART

An optical lens formed of a transparent plastic material such as acrylic resin or PMMA is used in various optical devices. When compared to optical glass, conventional plastic materials usable for production of the optical lenses have defects such as a refractive index cannot be increased to a high value and a focal length varies according to changes in the refractive index with temperature. To overcome the defects, the use of various nanocomposite materials (organic-inorganic hybrid materials) in which inorganic fine particles of nano-order is dispersed into a plastic matrix is examined.

A nanocomposite material disclosed in Japanese Patent Laid-Open Publication No. 2005-055852 is prepared by dispersing Niobium oxide (Nb₂O₅) having a maximum length (particle diameter) of 30 nm or less into a transparent plastic matrix. The refractive index of this nanocomposite material cannot be increased to a high value. However, the nanocomposite material offsets a reduction in the refractive index of the plastic matrix by an increase in the refractive index of the inorganic fine particles as the temperature increases. Accordingly, variations in the total refractive index are prevented. The above publication discloses that the maximum length of the Niobium Oxide to be dispersed is preferably 20 nm, and more preferably within a range of 10 nm to 15 nm to prevent a significant reduction in optical transmittance.

On the other hand, in order to prepare a nanocomposite material having a high refractive index, it is known to select inorganic fine particles having a high refractive index and increase an amount of the selected inorganic fine particles to be dispersed into a plastic matrix. However, according to the research of the applicant, fine particles with a large particle diameter of approximately 30 nm have low transparency to visible light and therefore are not suitable for a material of an optical lens. FIG. 1 shows a result of a simulation of optical transmittance of a nanocomposite material (with the thickness of 1 mm and a refractive index of 1.70) prepared by dispersing 21.2 vol % of inorganic fine particles of zirconium oxide (ZrO₂) having a refractive index of 2.1 into a transparent plastic matrix having a refractive index of 1.60. According to the result of the simulation, the inorganic fine particles having the particle diameter of approximately 30 nm has no practical utility. The upper practical size limit for the particle diameter is 15 nm. It is more preferable that the particle diameter is at most 10 nm. It is furthermore preferable that the particle diameter is at most 7 nm.

Based on the above simulation, in order to prepare a nanocomposite material with excellent optical transmittance for use in an optical lens, it is necessary to make a particle diameter of inorganic fine particles to be dispersed into a plastic matrix less than 10 nm so as to achieve a high refractive index and improve temperature properties. However, the inorganic fine particles with smaller particle diameter are more likely to aggregate with each other. Accordingly, it becomes difficult to homogeneously disperse the inorganic fine particles in the plastic matrix. The nanocomposite material in which the inorganic fine particles are nonuniformly distributed in the plastic matrix has locally nonuniform optical properties such as the refractive index and the optical transmittance. An optical lens made of such nanocomposite material cannot achieve desired optical properties.

Even if the above optical properties such as the refractive index and the optical transmittance are satisfactory, there are inorganic fine particles whose optical transmittance is reduced upon exposure to UV rays, for example, titanium oxide (TiO₂). Such inorganic fine particles have particularly small particle diameter of less than 10 nm, and become more sensitive to UV rays as the inorganic fine particles are dispersed more homogeneously in the plastic matrix. Accordingly, resistance to UV rays is gradually reduced in the optical lens made of the nanocomposite material containing such inorganic fine particles, and it is concerned that the optical lens becomes practically useless due to deterioration of optical transmittance with time.

In view of the foregoing, an object of the invention is to provide an optical lens having uniform transmittance properties, a uniform refractive index profile, and sufficient resistance to UV rays although the optical lens is made of a nanocomposite material in which inorganic fine particles are dispersed into a plastic matrix for the purpose of achieving a high refractive index and improving temperature properties. Another object is to provide an optical system unit and an imaging apparatus including the optical lens.

### DISCLOSURE OF INVENTION

In order to achieve the above objects and other objects, an optical lens of the invention is produced from a nanocomposite material (organic-inorganic hybrid material) having the following specific structure. In order to homogeneously disperse inorganic fine particles having a particle diameter (maximum length) of preferably less than 10 nm into a plastic matrix, a thermoplastic polymer (thermoplastic) having a functional group, in a main chain end or a side chain, that forms a chemical bond with at least one of the inorganic fine particles is used. The functional group is bonded to the inorganic fine particle and thereby the polymer chain is bonded to the inorganic fine particle. Each inorganic fine particle is surrounded with the polymer chain(s), so that a space is kept between the inorganic fine particles. Thus, the inorganic fine particles are homogeneously dispersed in the plastic matrix. An optical lens made of such nanocomposite material exhibit excellent optical properties such as high optical transmittance and uniform refractive index. In addition, the optical lens of the invention is provided with a UV blocking element on a light incident surface of the optical lens so as to limit passage of UV rays. Thereby, the dispersed inorganic fine particles are not directly exposed to UV rays.

A film that limits passage of UV rays can be adhered to the light incident surface of the optical glass as the UV blocking element. It is preferable to apply coating of the thin film that blocks UV rays to the light incident surface of the optical glass. It is preferable to use a multilayer interference thin film formed by vacuum vapor deposition or spattering so as not to influence transmittance in a wavelength range of visible light region. In an optical system unit combining the optical lens made of the above described nanocomposite material of the invention and other optical component(s), it is also possible to provide the UV blocking element to the optical component placed forward of and on the light incident side from the optical lens.

The optical lens made of the nanocomposite material having the above-described specific structure is resistant to heat, and softening and deformation rarely occur by heat when compared to the conventional plastic lens. Accordingly, although the optical lens is made of plastic, the optical lens of the invention can be used in a location having wide temperature variations. In addition, the optical lens is stably mass-produced by exploiting the thermoplastic characteristic of the plastic lens, through injection molding and press forming using a mold having a spherical or a nonspherical surface, resulting in low production cost. It is also possible to make the refractive index to be at least 1.65 by appropriately selecting the plastic matrix and inorganic fine particles.

According to the invention, the optical lens made of the above-described nanocomposite material has significantly high transparency, uniform refractive index profile, and excellent optical properties when compared to the optical lens made of the conventional nanocomposite material. Since the size of the inorganic fine particles which affects adjustment of the refractive index is smaller and the inorganic fine particles are more homogeneously dispersed in the plastic matrix than the conventional inorganic fine particles, the above-described nanocomposite material exhibits a compensation effect more capable of following temperature changes in suppressing variations of refractive index with temperature. The optical lens, the optical system unit, and the imaging apparatus with high durability are produced by the combined use of the optical lens of the invention and the UV blocking element, preventing reduction of transparency of the inorganic fine particles due to UV exposure.

### BRIEF DESCRIPTION OF DRAWINGS

FIG. 1 is a graph showing a correlation between a particle diameter of inorganic fine particles and optical transmittance when fine particles of nano-order are dispersed into a plastic matrix;

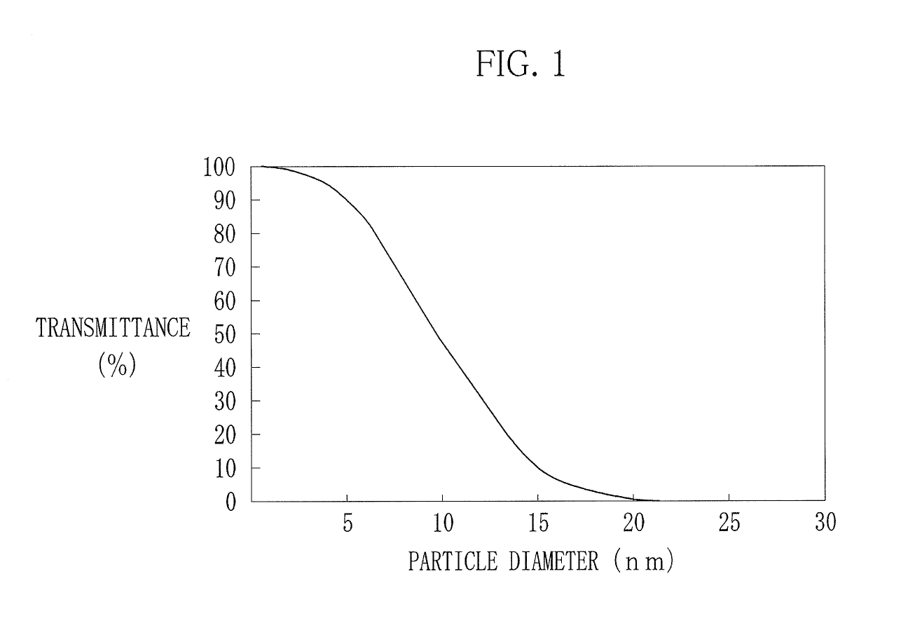

FIG. 2 is an explanatory view of a vehicle-mounted surveillance camera;

FIG. 3 is a schematic view showing a lens configuration of an optical system unit of the invention;

FIG. 4 is a graph showing spectral transmittance of a thin film layer; and

FIG. 5 is a schematic view of an example of applying the thin film layer to other optical component.

### BEST MODE FOR CARRYING OUT THE INVENTION

[Thermoplastic Polymer]

A thermoplastic polymer (thermoplastic resin) effectively used for production of an optical lens of the invention has a functional group, in at least one of a main chain end (polymer chain end) or a side chain, capable of forming any kind of chemical bond with inorganic fine particles.

Preferable examples of such thermoplastic polymer include:
(1) a thermoplastic polymer having at least one of functional groups in a side chain, and such functional group is selected from the following,

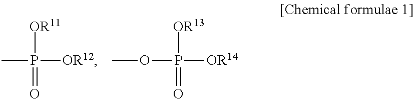

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR¹⁵)ₘ₁R¹⁶₃₋ₘ₁ [each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3];
(2) a thermoplastic polymer having at least one of functional groups in at least a part of a main chain end, and such functional group is selected from the following,

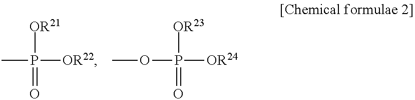

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3]; and
(3) a block copolymer composed of a hydrophobic segment and a hydrophilic segment.

Hereinafter, the thermoplastic polymers (1) to (3) are detailed.

Thermoplastic Polymer (1)

The thermoplastic polymer (1) used in the invention has a functional group, in a side chain, capable of forming a chemical bond with inorganic fine particles. The “chemical bond” used herein includes, for example, a covalent bond, an ionic bond, a coordinate bond, and a hydrogen bond. Where a thermoplastic polymer (1) has plural functional groups, each functional group may form a different chemical bond with inorganic fine particles. Whether a functional group is capable of forming a chemical bond with inorganic particles is determined by the presence of a chemical bond between the functional group and the inorganic fine particles when the thermoplastic polymer and the inorganic fine particles are dispersed in an organic solvent. All or a part of the functional groups of the thermoplastic polymer may form chemical bonds with inorganic fine particles.

The functional group capable of forming the chemical bond with the inorganic fine particles stably disperses the inorganic fine particles in the thermoplastic polymer by forming the chemical bond with the inorganic fine particles. Such functional group is selected from

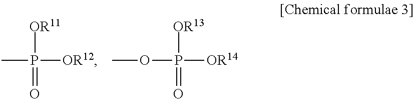

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, or —Si(OR¹⁵)ₘ₁R¹⁶₃₋ₘ₁ [each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3].

The alkyl group has preferably from one to 30 carbon atoms, and more preferably from one to 20 carbon atoms, and examples thereof include a methyl group, an ethyl group, and an n-propyl group. The substituted alkyl group includes, for example, an aralkyl group. The aralkyl group has preferably from 7 to 30 carbon atoms, and more preferably from 7 to 20 carbon atoms, and examples thereof include a benzyl group, and a p-methoxybenzyl group. The alkenyl group has preferably from 2 to 30 carbon atoms, and more preferably from 2 to 20 carbon atoms, and examples thereof include a vinyl group and a 2-phenylethenyl group. The alkynyl group has preferably from 2 to 20 carbon atoms, and more preferably from 2 to 10 carbon atoms, and examples thereof include an ethynyl group, and a 2-phenylethynyl group. The aryl group has preferably from 6 to 30 carbon atoms, and more preferably from 6 to 20 carbon atoms, and examples thereof include a phenyl group, a 2, 4, 6-tribromophenyl group, and a 1-naphthyl group. The aryl group used herein includes a heteroaryl group. Examples of substituents for the alkyl group, the alkenyl group, the alkynyl group, and the aryl group include a halogen atom (for example, a fluorine atom, a chlorine atom, a bromine atom, and an iodine atom) and an alkoxy group (for example, a methoxy group or an ethoxy group) in addition to the above-described alkyl group, the alkenyl group, the alkynyl group, and the aryl group.

Preferable number of atoms, functional groups, and substituents for the R¹⁵ and R¹⁶ are the same as those for R¹¹, R¹², R¹³, R¹⁴. The m1 is preferably 3.

Of the above functional groups, preferable are

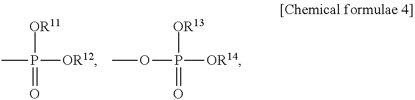

—SO₃H, —CO₂H, or —Si(OR¹⁵)ₘ₁R¹⁶₃₋ₘ₁. More preferable functional groups are

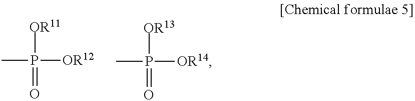

or —CO₂H. Especially preferable functional groups are

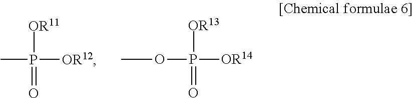

It is especially preferable that the thermoplastic polymer used in the invention is a copolymer having a repeating unit represented by a general formula (1) below. Such copolymer is synthesized by copolymerization of vinyl monomers represented by a general formula (2) below.

General Formula (1)

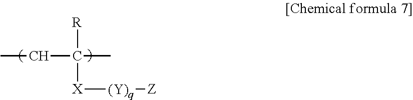

General Formula (2)

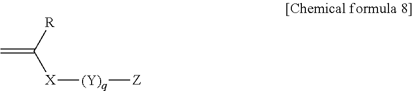

In the general formulae (1) and (2), “R” represents one of a hydrogen atom, a halogen atom, and a methyl group. “X” represents a bivalent linking group selected from a group consists of —CO₂—, —OCO—, —CONH—, —OCONH—, —OCOO—, —O—, —S—, —NH—, and a substituted or unsubstituted arylene group. It is more preferable that “X” is —CO₂— or a p-phenylene group.

“Y” represents a bivalent linking group having 1 to 30 carbon atoms. The number of the carbon atoms is preferably 1 to 20, more preferably 2 to 10, and furthermore preferably 2 to 5. More specifically, an alkylene group, an alkyleneoxy group, an alkyleneoxycarbonyl group, an arylene group, an aryleneoxy group, an aryleneoxycarbonyl group, and a combination of the above groups may be used. In particular, the alkylene group is preferable.

“q” represents an integer from zero to 18. It is more preferable that “q” is an integer from zero to 10. It is furthermore preferable that “q” is an integer from zero to 5. It is especially preferable that “q” is zero or one.

“Z” represents a functional group selected from a group consists of

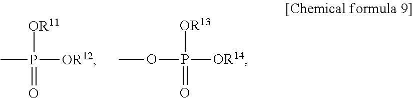

—SO₃H, —OSO₃H, —CO₂H and —Si(OR¹⁵)ₘ₁R¹⁶₃₋ₘ₁. Preferable functional groups are

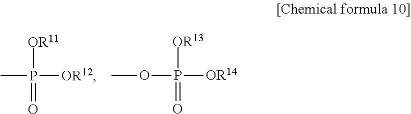

More preferable functional group is

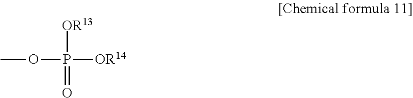

Here, definitions and specific examples of R¹¹, R¹², R¹³, R¹⁴, R¹⁵, R¹⁶ and m1 are the same as those of the R¹¹, R¹², R¹³, R¹⁴, R¹⁵, R¹⁶ and m1 previously described, except that each of R¹¹, R¹², R¹³, R¹⁴, R¹⁵, and R¹⁶ is a hydrogen atom or an alkyl group.

Hereinafter, specific examples of monomers represented by a general formula (2) are described. However, monomers usable in the invention are not limited to these examples.

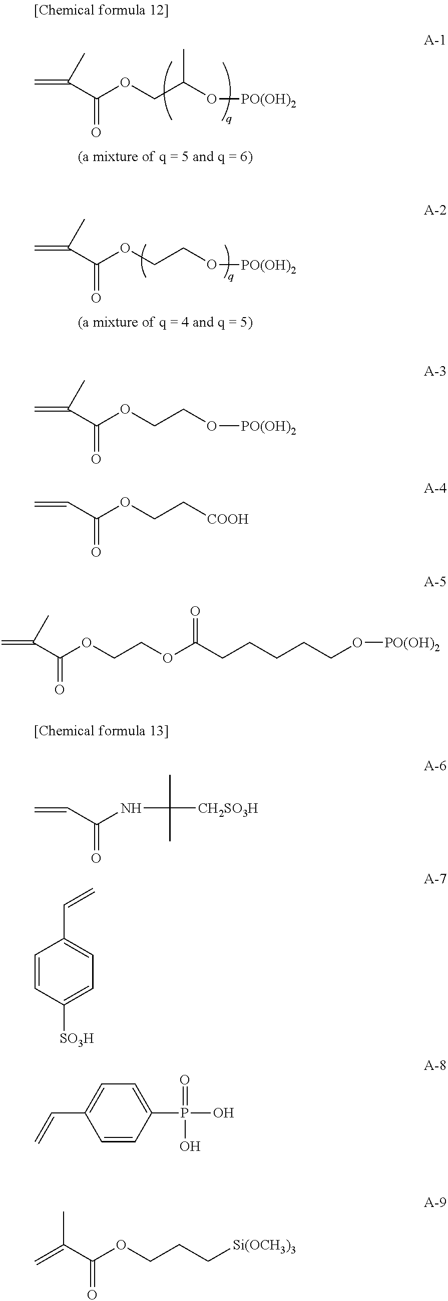

Other kinds of monomers copolymerizable with the monomer represented by the above general formula (2) are described in pages one to 483, in chapter 2 of “Polymer Handbook 2^{nd} ed.”, J. Brandrup, Wiley Interscience (1975).

Specifically, for example, compounds having one addition-polymerizable unsaturated bond selected from styrene derivatives, 1-vinylnaphthalene, 2-vinylnaphthalene, vinylcarbazole, acrylic acid, methacrylic acid, acrylic esters, methacrylic esters, acrylamides, methacrylamides, allyl compounds, vinyl ethers, vinyl esters, dialkyl itaconates, and dialkyl esters or monoalkyl esters of fumaric acid, can be exemplified.

Examples of the styrene derivative include styrene, 2,4,6-tribromostyrene, 2-phenylstyrene.

Examples of the acrylic esters include methyl acrylate, ethyl acrylate, propyl acrylate, n-butyl acrylate, tert-butyl acrylate, chloroethyl acrylate, 2-hydroxyethyl acrylate, trimethylolpropane monoacrylate, benzyl acrylate, methoxybenzyl acrylate, furfuryl acrylate, and tetrahydrofurfuryl acrylate.

Examples of the methacrylic esters include methyl methacrylate, ethyl methacrylate, propyl methacrylate, butyl methacrylate, tert-butyl methacrylate, chloroethyl methacrylate, 2-hydroxyethyl methacrylate, trimethylolpropane monomethacrylate, benzyl methacrylate, methoxybenzyl methacrylate, furfuryl methacrylate, and tetrahydrofurfuryl methacrylate.

Examples of the acrylamides include acrylamide, N-alkyl acrylamide (with an alkyl group having 1 to 3 carbon atoms, such as a methyl group, an ethyl group, or a propyl group), N,N-dialkyl acrylamide (with an alkyl group having 1 to 6 carbon atoms), N-hydroxyethyl-N-methyl acrylamide and N-2-acetamideethyl-N-acetyl acrylamide.

Examples of the methacrylamides include methacrylamide, N-alkyl methacrylamide (with an alkyl group having 1 to 3 carbon atoms, such as a methyl group, an ethyl group, or a propyl group), N,N-dialkyl methacrylamide (with an alkyl group having 1 to 6 carbon atoms), N-hydroxyethyl-N-methyl methacrylamide and N-2-acetamideethyl-N-acetyl methacrylamide.

Examples of the allyl compounds include allyl esters (for example, allyl acetate, allyl caproate, allyl caprylate, allyl laurate, allyl palmitate, allyl stearate, allyl benzoate, allyl acetoacetate and allyl lactate), and allyl oxyethanol.

Examples of the vinyl ethers include alkyl vinyl ethers with an alkyl group having 1 to 10 carbon atoms, such as hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether and tetrahydrofurfuryl vinyl ether.

Examples of the vinyl esters include vinyl butyrate, vinyl isobutyrate, vinyl trimethyl acetate, vinyl diethyl acetate, vinyl pivalate, vinyl caproate, vinyl chloroacetate, vinyl dichloroacetate, vinyl methoxyacetate, vinyl butoxyacetate, vinyl lactate, vinyl-β-phenyl butylate and vinyl cyclohexyl carboxylate.

Examples of the dialkyl itaconates include dimethyl itaconate, diethyl itaconate and dibutyl itaconate. Examples of dialkyl esters or monoalkyl esters of the fumaric acid include dibutyl fumarate.

In addition, crotonic acid, itaconic acid, acrylonitrile, methacrylonitrile, maleonitrile and the like can be exemplified.

The thermoplastic polymer (1) used in the invention has a number average molecular weight of preferably from 1,000 to 500,000, more preferably from 3,000 to 300,000, and especially preferably from 10,000 to 100,000. Where the number average molecular weight of the thermoplastic polymer (1) is at most 500,000, processability of the thermoplastic polymer (1) improves, and where it is at least 1,000, mechanical strength increases.

The “number average molecular weight” used herein is a polystyrene equivalent molecular weight based on detection by a differential refractometer of a GPC analyzer with columns of TSK gel GMHXL, TSK gel G4000HxL, and TSK gel G2000HxL (trade names of Tosoh Corporation) using tetrahydrofuran as a solvent.

In the thermoplastic polymer (1) used in the invention, the average number of the functional group that bonds to the inorganic fine particles per polymer chain is preferably from 0.1 to 20, more preferably from 0.5 to 10, and especially preferably from 1 to 5. Where the average number of the functional group is at most 20 per polymer chain, gelation and an increase in viscosity in a solution state caused by coordination of the thermoplastic polymer (1) to plural inorganic fine particles is prevented. Where the average number of the functional group per polymer chain is at least 0.1, the inorganic fine particles are dispersed stably.

A glass transition temperature of the thermoplastic polymer (1) used in the invention is preferably 80° C. to 400° C., and more preferably 130° C. to 380° C. An optical component having sufficient heat resistance is produced from a thermoplastic polymer having the glass transition temperature of at least 80° C. Processability is improved by using the thermoplastic polymer having the glass transition temperature of at most 400° C.

Where there is a significant difference between a refractive index of the thermoplastic polymer (1) and a refractive index of the inorganic fine particles, Rayleigh scattering is likely to occur. As a result, the amount of the inorganic fine particles to be dispersed in the thermoplastic polymer (1) needs to be reduced to maintain transparency of a molded product. Where the refractive index of the thermoplastic polymer (1) is approximately 1.48, the transparent molded product having the refractive index in a level of 1.60 can be provided. To achieve the refractive index of at least 1.65, the refractive index of the thermoplastic polymer (1) used in the invention is preferably at least 1.55, and more preferably at least 1.58. These refractive indices are measured at 589 nm wavelength at 22° C.

The thermoplastic polymer (1) used in the invention has a light transmittance of preferably at least 80%, more preferably at least 85%, and especially preferably at least 88%, at 589 nm wavelength with the thickness of 1 mm.

Hereinafter, preferable specific examples of the thermoplastic polymer (1) that can be used in the invention are described, but the thermoplastic polymer that can be used in the invention is not limited to the following examples.

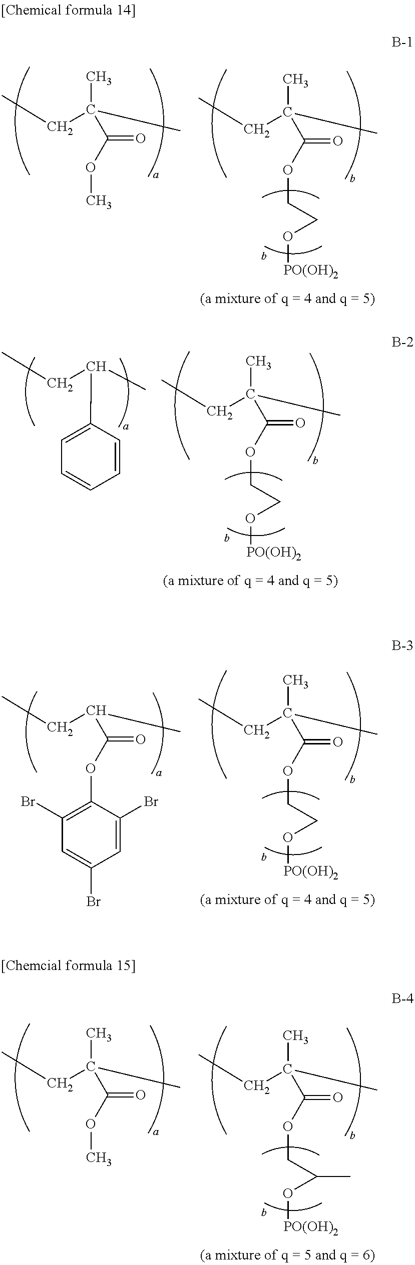

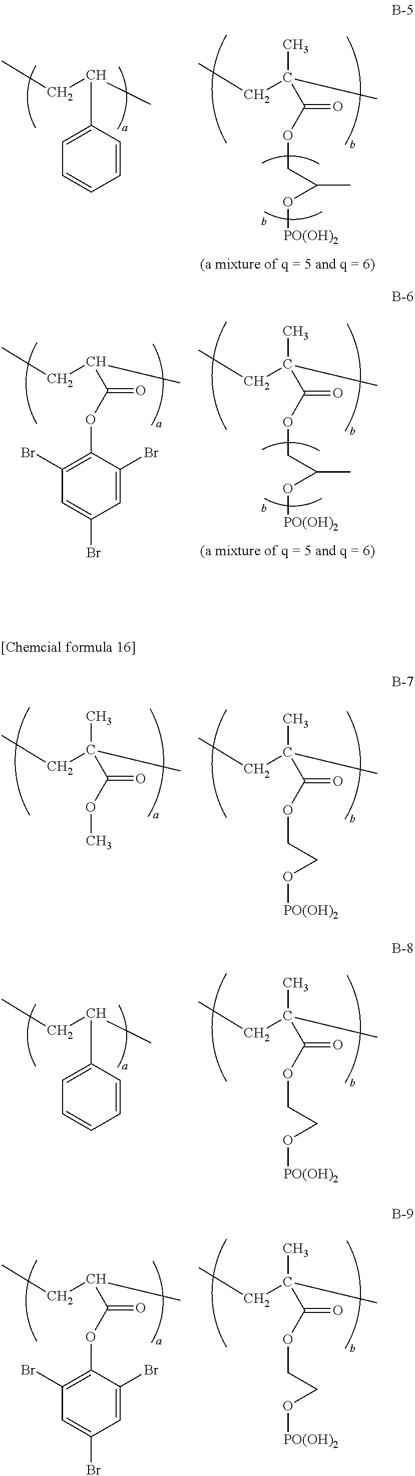

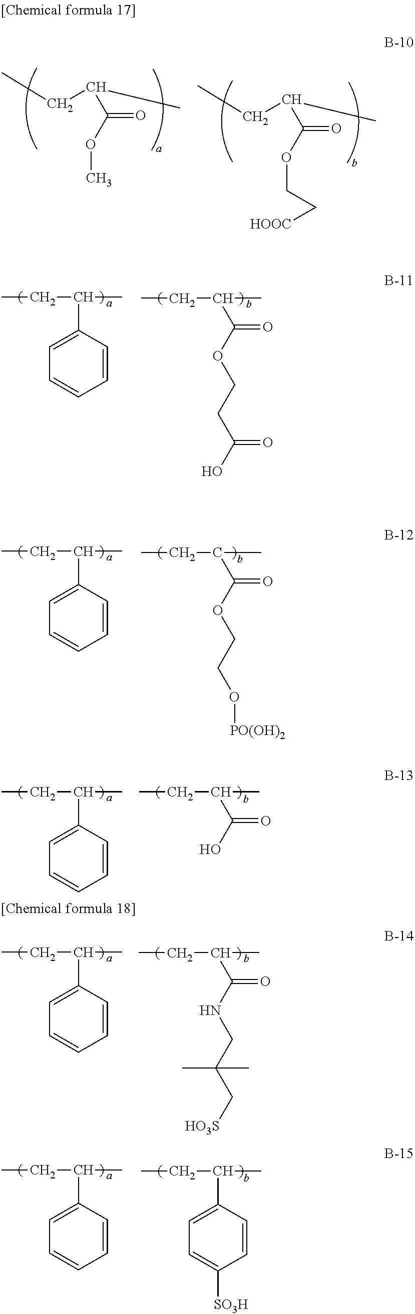

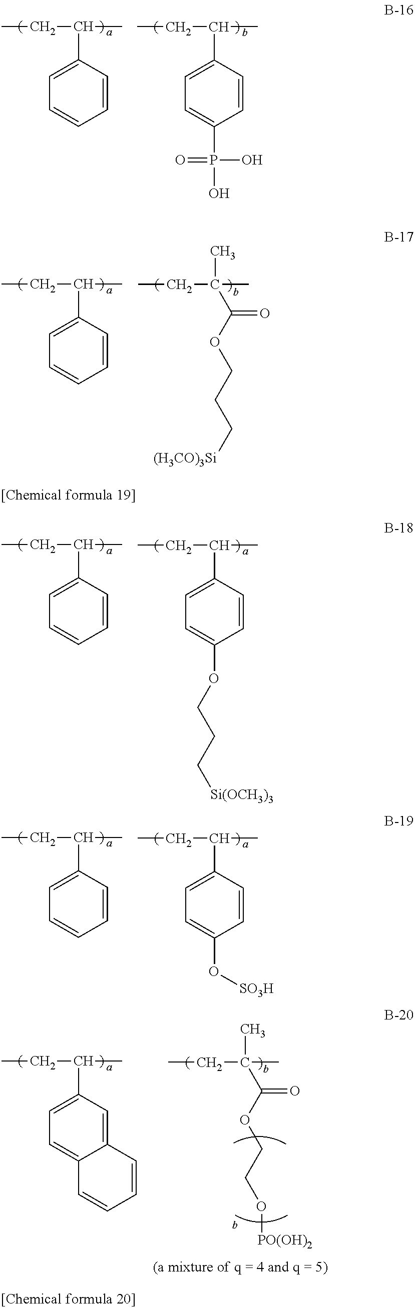

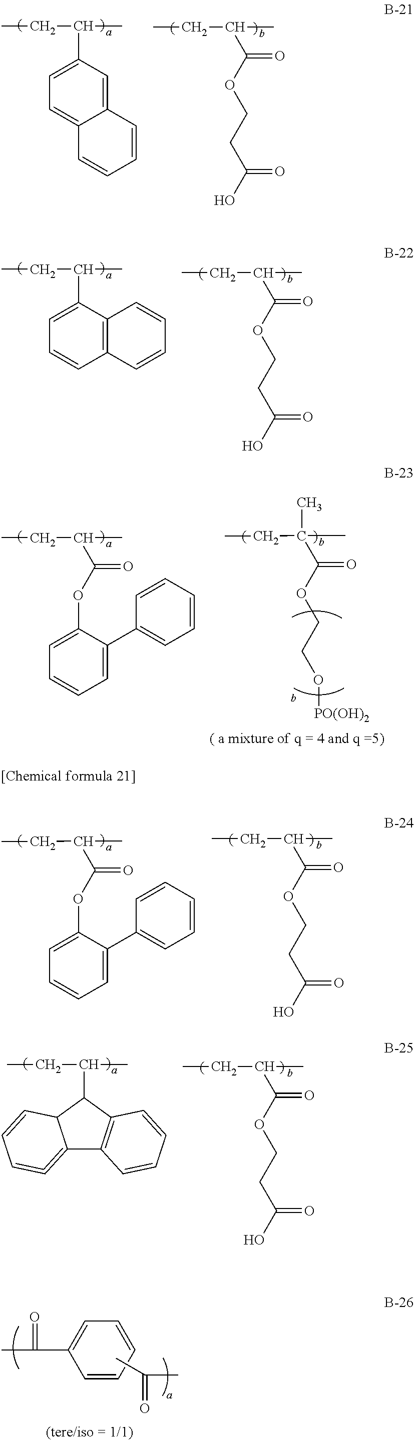

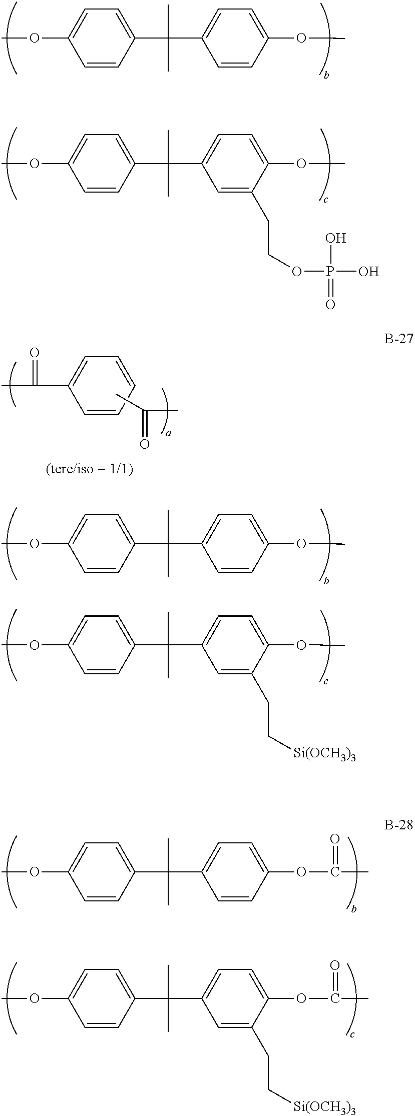

The thermoplastic polymer (1) may be one kind or a mixture of two or more kinds of the above-mentioned thermoplastic polymers. In addition, the thermoplastic polymer (1) may be mixed with a thermoplastic polymer (2) and/or a thermoplastic polymer (3).

Thermoplastic Polymer (2)

The thermoplastic polymer (2) used in the invention has a functional group, in at least a part of a main chain end, capable of forming a chemical bond with inorganic fine particles. The functional group may be present in one or both of the main chain ends. However, it is preferable that the functional group is present only in one of the main chain ends. Plural functional groups may be present in the main chain end. The “main chain end” refers to a moiety of the polymer excluding a repeating unit and a structure sandwiched between repeating units. The “chemical bond” is considered similar to that in the above-described thermoplastic polymer (1).

The functional group capable of forming a chemical bond with inorganic fine particles is a selected one of

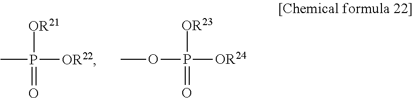

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3].

In the case each of R²¹, R²², R²³, R²⁴, R²⁵, and R²⁶ is a substituted or unsubstituted alkyl group, a substituted or unsubstituted alkenyl group, a substituted or unsubstituted alkynyl group, or a substituted or unsubstituted aryl group, preferable number of carbon atoms, functional groups, and substituents for R²¹, R²², R²³, R²⁴, R²⁵, and R²⁶ are the same as those for R¹¹, R¹², R¹³, R¹⁴, (R¹⁵, and R¹⁶). It is preferable that m2 is 3.

Of the above functional groups, preferable are

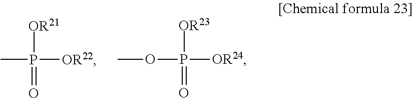

—SO₃H, —CO₂H, and —Si(OR²⁵)ₘ₂R²⁶₃₋ₘ₂. More preferable functional groups are

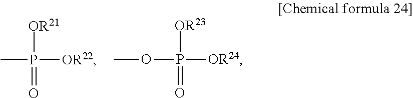

—SO₃H, and —CO₂H. Especially preferable functional groups are

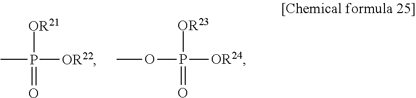

and —SO₃H.

A basic skeleton of the thermoplastic polymer (2) in the invention is not particularly limited. A well known polymer structure such as that of poly(meth)acrylic ester, polystyrene, polyvinyl carbazole, polyarylate, polycarbonate, polyurethane, polyimide, polyether, polyether sulfone, polyether ketone, polythioether, cycloolefin polymer, and cycloolefin copolymer can be employed. A vinyl polymer, a polyarylate and an aromatic group-containing polycarbonate are preferable, and a vinyl polymer is more preferable. Specific examples are the same as those described for the thermoplastic polymer (1).

The thermoplastic polymer (2) used in the invention has a refractive index of preferably at least 1.50, more preferably at least 1.55, further preferably at least 1.60, and especially preferably at least 1.65. The refractive index used herein is measured using an Abbe's refractometer (a product of Atago, Model: DR-M4) with incident light of 589 nm wavelength.

The thermoplastic polymer (2) used in the invention has a glass transition temperature of preferably from 50° C. to 400° C., and more preferably from 80° C. to 380° C. Where the thermoplastic polymer (2) has a glass transition temperature of at least 50° C., heat resistance increases. Where the thermoplastic polymer (2) has a glass transition temperature of at most 400° C., processing becomes facilitated.

The thermoplastic polymer (2) used in the invention has a light transmittance of preferably at least 80%, and more preferably at least 85%, at 589 nm wavelength with the thermoplastic polymer thickness of 1 mm.

The thermoplastic polymer (2) used in the invention has a number average molecular weight of preferably from 1,000 to 500,000. The number average molecular weight is preferably from 3,000 to 300,000, and more preferably from 5,000 to 200,000, and especially preferably from 10,000 to 100,000. With the use of the thermoplastic polymer (2) having the number average molecular weight of at least 1,000, mechanical strength increases. With the use of the thermoplastic polymer (2) having the number average molecular weight of at most 500,000, processability of the thermoplastic polymer improves.

A method of introducing the functional group into the main chain end is not particularly limited. For example, as described in Chapter 3 Terminal Reactive Polymer of “New Polymer Experimental Studies 4, Synthesis and Reaction of Polymer (3) Reaction and Decomposition of Polymer” edited by the Society of Polymer Science, Japan, the functional group may be introduced at the time of polymerization, or after polymerization. In the case the functional group is introduced after polymerization, the polymer is isolated and then subjected to terminal functional group transformation or main chain decomposition. It is also possible to use polymer reactions such as a method of synthesizing polymer by polymerization using an initiator, a terminator, a chain transfer agent or the like having a functional group and/or a protected functional group, and a method in which a phenol terminal of polycarbonate synthesized from, for example, bisphenol A is modified with a reacting agent containing a functional group. For example, radical polymerization of vinyl monomer by a chain transfer method using a sulfur-containing chain transfer agent, described in pages 110-112 of “New Polymer Experimental Studies 2, Synthesis and Reaction of Polymer (1) Synthesis of Addition-Type Polymer” edited by the Society of Polymer Science, Japan; living cationic polymerization using a functional group-containing initiator and/or a functional group-containing terminator, described in pages 255-256 “New Polymer Experimental Studies 2, Synthesis and Reaction of Polymer (1) Synthesis of Addition-Type Polymer” edited by the Society of Polymer Science, Japan; and ring-opening metathesis polymerization using a sulfur-containing chain transfer agent, described in pages 7020-7026 of Macromolecules, vol. 36, (2003) can be exemplified.

Preferable specific examples of the thermoplastic polymer (2) that can be used in the invention are described in the following illustrated compounds P-1 to P-22, but the thermoplastic polymer (2) is not limited to such examples. The structure in parentheses shows a repeating unit, and x and y of the repeating unit represent a copolymerization ratio (molar ratio).

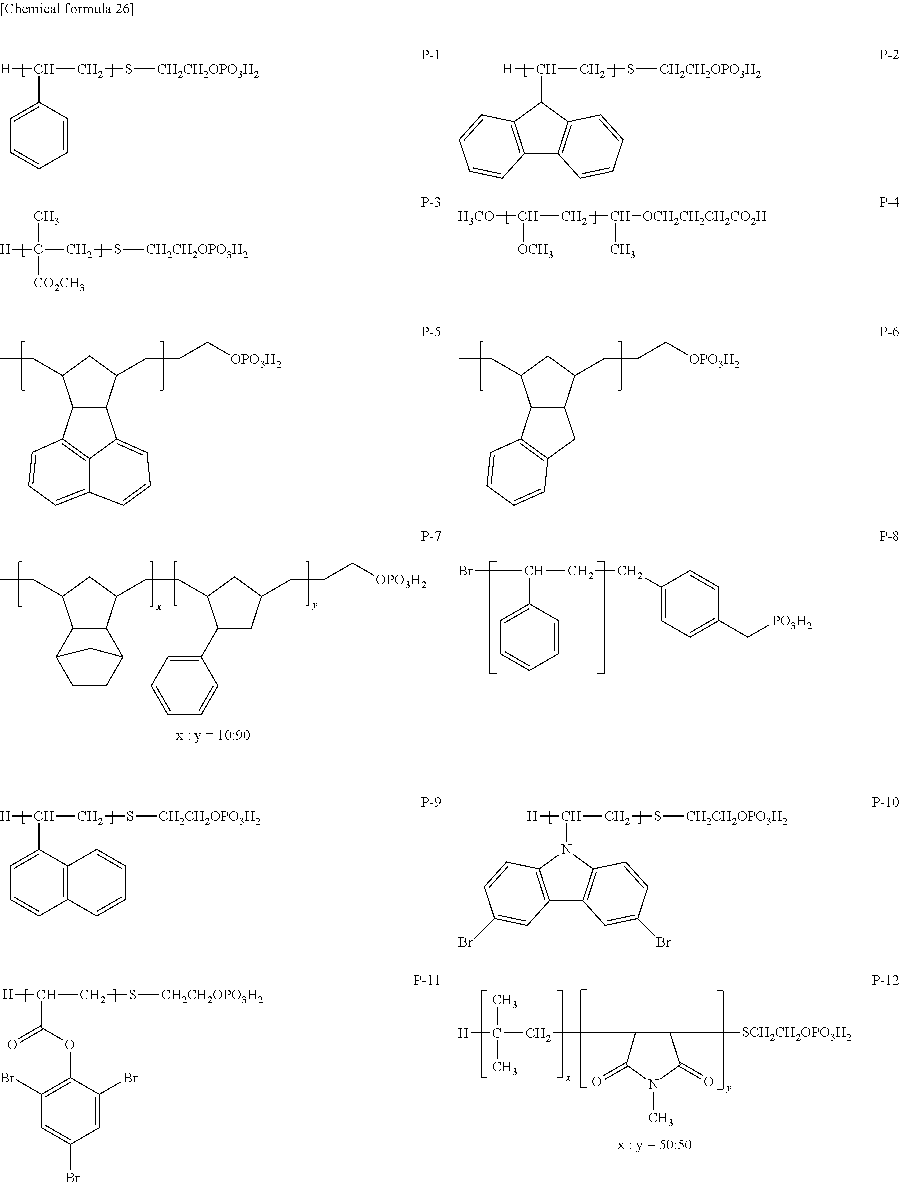

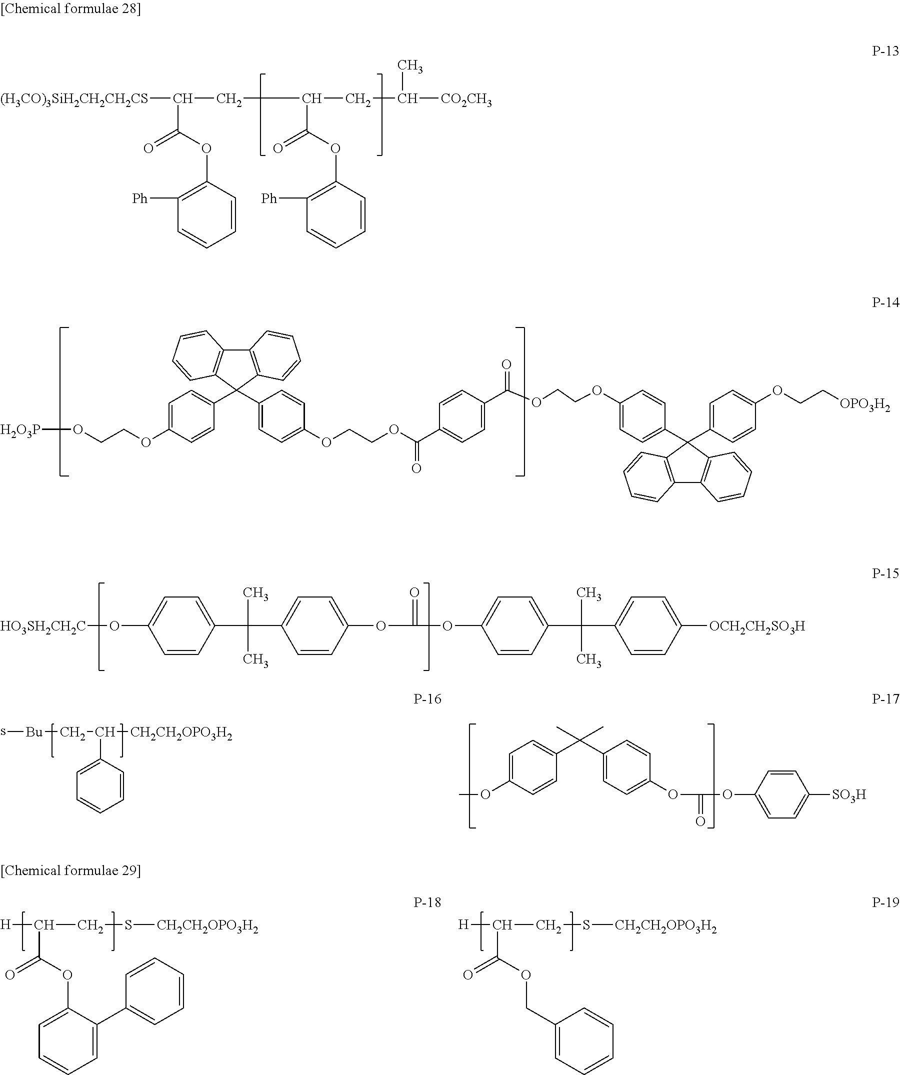

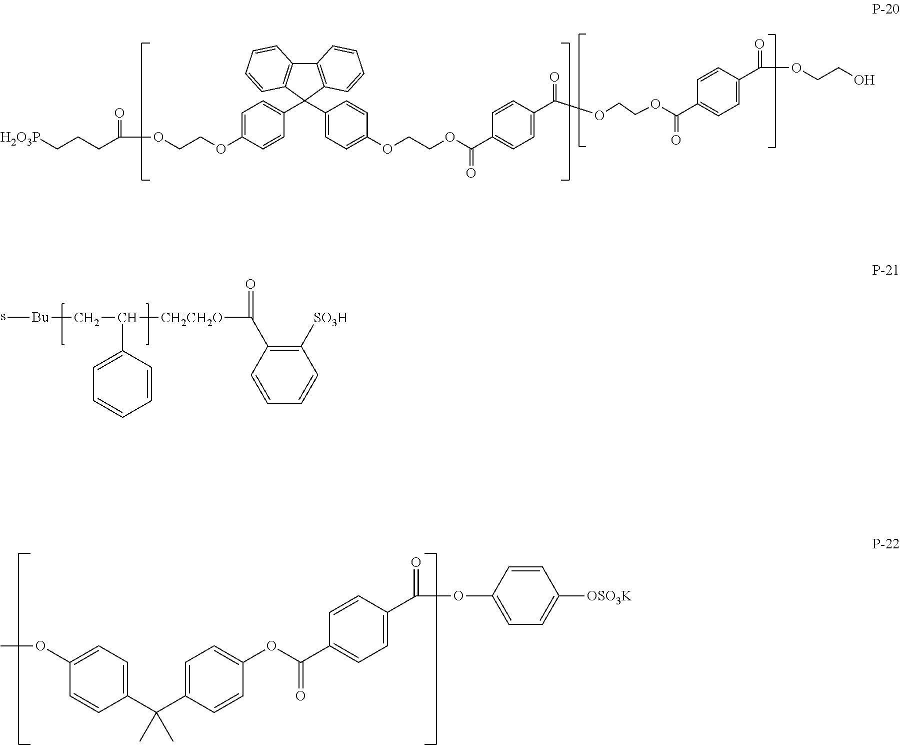

One kind or a mixture of two or more kinds of the above-mentioned thermoplastic polymers (2) may be used. These thermoplastic polymers (2) may contain other copolymerization components.

Thermoplastic Polymer (3)

A thermoplastic polymer (3) used in the invention is a block copolymer composed of a hydrophobic segment (A) and a hydrophilic segment (B).

The hydrophobic segment(s) (A) make up the polymer that is not soluble in water nor methanol. The hydrophilic segment(s) (B) make up the polymer soluble in at least one of water and methanol. Types of the block copolymer include AB type, B¹AB² type, and A¹BA² type. In the B¹AB² type, two hydrophilic segments B¹ and B² may be the same or different. In the A¹BA² type, two hydrophobic segments A¹ and A² may be the same or different. In view of dispersibility, the block copolymers of the AB type or the A¹BA² type are preferable. In view of production suitability, the AB type or the ABA type (the A¹BA² type in which the two hydrophobic segments A¹ and A² are the same) is preferable, and the AB type is especially preferable.

Each of the hydrophobic segment (A) and the hydrophilic segment (B) may be selected from well known polymers such as vinyl polymer obtained by polymerization of vinyl monomers, polyether, ring-opening metathesis polymerization polymer and condensation polymer (polycarbonate, polyester, polyamide, polyether ketone, polyether sulfone, and the like). In particular, vinyl polymer, ring-opening metathesis polymerization polymer, polycarbonate, and polyester are preferable. In view of production suitability, vinyl polymer is more preferable.

Examples of vinyl monomer (a) forming the hydrophobic segment (A) include the following: acrylic esters, methacryl esters (an ester group is a substituted or unsubstituted aliphatic ester group or a substituted or unsubstituted aromatic ester group, for example, a methyl group, a phenyl group, a naphthyl group, or the like);

acryl amides, methacryl amides, more specifically, N-monosubstituted acrylamides, N-disubstituted acrylamides, N-monosubstituted methacrylamides, N-disubstituted methacrylamides (substituents of a monosubstitution product and disubstitution product include a substituted or unsubstituted aliphatic group, and a substituted or unsubstituted aromatic group, for example, a methyl group, a phenyl group, a naphthyl group, or the like);

olefins, more specifically, dicyclopentadiene, norbornene derivative, ethylene, propylene, 1-buten, 1-penten, vinyl chloride, vinylidene chloride, isoprene, chloroprene, butadiene, 2,3-dimethylbutadiene, and vinyl carbazole; styrenes, more specifically, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, tribromostyrene, and vinylbenzoic acid methyl ester; and

vinyl ethers, more specifically, methyl vinyl ether; butyl vinyl ether, phenyl vinyl ether, and methoxyethyl vinyl ether; other monomers such as butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methylvinyl ketone, phenylvinyl ketone, methoxyethyl vinyl ketone, N-vinyl oxazolidone, N-vinyl pyrrolidone, vinylidene chloride, methylene malononitrile, vinylidene, diphenyl-2-acryloyloxyethyl phosphate, diphenyl-2-methacryloyloxyethyl phosphate, dibutyl-2-acryloyloxyethyl phosphate, and dioctyl-2-methacryloyloxyethyl phosphate.

In particular, acrylic esters and methacrylic esters whose ester group is an unsubstituted aliphatic group, or a substituted or unsubstituted aromatic group; N-monosubstituted acrylamides, N-disubstituted acrylamides, N-monosubstituted methacrylamides and N-disubstituted methacrylamides whose substituent is an unsubstituted aliphatic group, or substituted or unsubstituted aromatic group; and styrenes are preferable. Acrylic esters and methacryl esters whose ester group is substituted or unsubstituted aromatic group; and styrenes are more preferable.

Examples of the vinyl monomer (b) forming the hydrophilic segment (B) include the following: acrylic acid, methacrylic acid, acrylic esters and methacrylic esters having a hydrophilic substituent at an ester moiety; styrenes having a hydrophilic substituent at an aromatic ring; vinyl ethers, acrylamides, methacryl amides, N-monosubstituted acrylamides, N-disubstituted acrylamides, N-monosubstituted methacrylamides, and N-disubstituted methacrylamides having a hydrophilic substituent.

The hydrophilic substituent preferably has a functional group selected from a group consists of

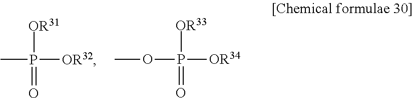

[Each of R³¹, R³², R³³, and R³⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, —OH, and —Si(OR³⁵)ₘ₃R³⁶₃₋ₘ₃ [each of R³⁵ and R³⁶ is a hydrogen atom, a substituted or unsubstituted alkyl group, a substituted or unsubstituted alkenyl group, a substituted or unsubstituted alkynyl group, or a substituted or unsubstituted aryl group, m3 is an integer from 1 to 3].

Where each of R³¹, R³², R³³, R³⁴, R³⁵, and R³⁶ is a substituted or unsubstituted alkyl group, a substituted or unsubstituted alkenyl group, a substituted or unsubstituted alkynyl group, or a substituted or unsubstituted aryl group, preferable number of atoms, functional groups, and substituents for R³¹, R³², R³³, R³⁴, R³⁵, and R³⁶ are the same as those for R¹¹, R¹², R¹³, R¹⁴, (R¹⁵, and R¹⁶). The m3 is preferably 3.

The functional group is preferably

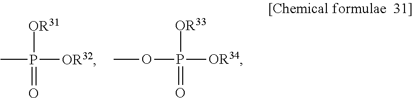

—CO₂H, or —Si(OR³⁵)m₃R³⁶₃₋ₘ₃, and more preferably,

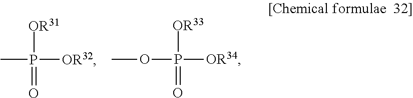

and —CO₂H,

and especially preferably,

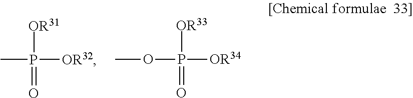

In the invention, it is preferable that the block copolymer has a functional group selected from

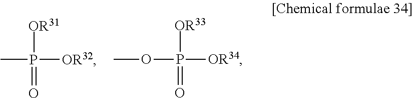

—SO₃H, —OSO₃H, —CO₂H, —OH, and —Si(OR³⁵)m₃R³⁶₃₋ₘ₃, and a content of the functional group is at least 0.05 mmol/g and at most 5.0 mmol/g.

In particular, the hydrophilic segment (B) is preferably acrylic acid, methacrylic acid, acrylic ester or methacrylic ester with a hydrophilic substituent at the ester moiety, and styrene having a hydrophilic substituent in an aromatic ring.

The hydrophobic segment (A) formed of the vinyl monomer (a) may also contain the vinyl monomer (b) within a range of not changing the hydrophobic property. It is preferable that a molar ratio between the vinyl monomer (a) and the vinyl monomer (b) contained in the hydrophobic segment (A) is 100:0 to 60:40.

The hydrophilic segment (B) formed of the vinyl monomer (b) may also contain the vinyl monomer (a) within a range of not changing the hydrophilic property. It is preferable that a molar ratio between the vinyl monomer (b) and the vinyl monomer (a) contained in the hydrophilic segment (B) is 100:0 to 60:40.

Each of the vinyl monomers (a) and (b) may be composed of one kind or two or more kinds of monomers. The vinyl monomers (a) and (b) are selected in accordance with the purpose (for example, to adjust acid content, to adjust glass transition temperature (Tg), to adjust solubility in organic solvent or water, or to adjust dispersion stability).

A content of the functional group relative to the total amount of the block copolymer is preferably 0.05 mmol/g to 5.0 mmol/g, and more preferably, 0.1 mmol/g to 4.5 mmol/g, and especially preferably 0.15 mmol/g to 3.5 mmol/g. Where the content of the functional group is too low, dispersion suitability may be reduced. Where the content of the functional group is too high, water solubility may become too high or an organic-inorganic hybrid material (nanocomposite material) may be gelated. In the block copolymer, the functional groups may form salts with cations such as alkali metal ions (for example, Na⁺, K⁺, or the like) or ammonium ions.

The number average molecular weight of the block copolymer is preferably 1000 to 100000, more preferably 2000 to 80000, and especially preferably 3000 to 50000. The block copolymer with the number average molecular weight of at least 1000 forms a stable dispersion. The block copolymer with the number average molecular weight of at most 100000 increases organic solvent solubility.

A refractive index of the block copolymer used in the invention is preferably at least 1.50, more preferably at least 1.55, furthermore preferably at least 1.60, and especially preferably at least 1.65. The refractive index used herein is measured using Abbe's refractometer (a product of Atago, model: DR-M4) with incident light of 589 nm wavelength.

A glass transition temperature of the block copolymer used in the invention is preferably in a range of 80° C. to 400° C., and more preferably 130° C. to 380° C. The block copolymer with the glass transition temperature of at least 80° C. increases heat resistance. The block copolymer with the glass transition temperature of at most 400° C. improves processability.

It is preferable that the block copolymer used in the invention has optical transmittance of at least 80% measured at the wavelength of 589 nm with the thickness of 1 mm. It is more preferable that the optical transmittance is at least 85%.

Specific examples of the block copolymers (illustrated compounds of P1 to P20) are listed in the following. However, the block copolymers used in the invention are not limited to the following specific examples.

TABLE 1

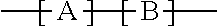

| | | mol | | mol | molecular |
|---|---|---|---|---|---|
| No. | —A— | % | —B— | % | weight |
| P-1 | 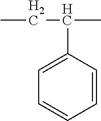 | 90 | 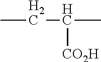 | 10 | 31000 |
| P-2 | 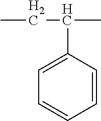 | 95 | 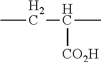 | 5 | 28000 |
| P-3 | 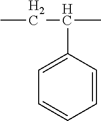 | 80 | 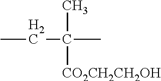 | 20 | 25000 |
| P-4 | 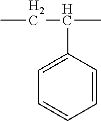 | 90 | 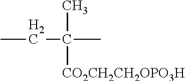 | 10 | 30000 |
| P-5 | 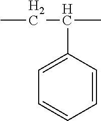 | 85 | 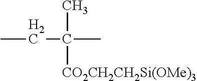 | 15 | 22000 |
| P-6 | 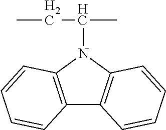 | 88 | 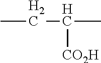 | 12 | 26000 |
| P-7 | 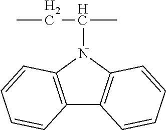 | 92 | 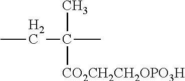 | 8 | 30000 |
| P-8 | 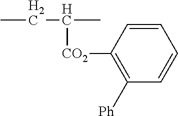 | 90 | 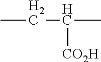 | 10 | 33000 |
| P-9 | 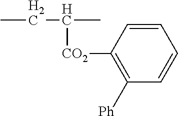 | 93 | 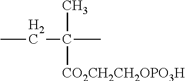 | 7 | 34000 |
| P-10 | 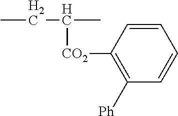 | 80 | 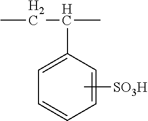 | 20 | 24000 |
| P-11 | 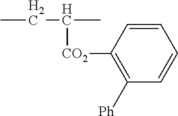 | 90 | 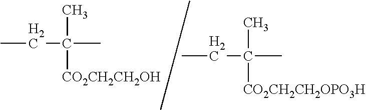 | 10 | 27000 |
| P-12 | 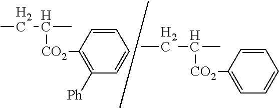 | 95 | 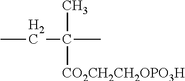 | 5 | 30000 |

TABLE 2

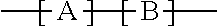

| | | mol | | mol | molecular |
|---|---|---|---|---|---|
| No. | —A— | % | —B— | % | weight |
| P-13 | 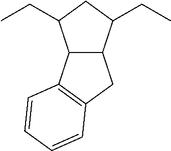 | 90 | 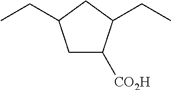 | 10 | 35000 |
| P-14 | 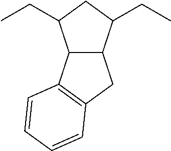 | 95 | 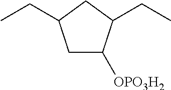 | 5 | 30000 |
| P-15 | 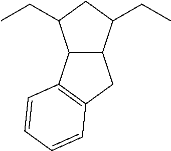 | 80 | 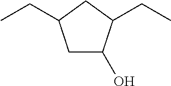 | 20 | 31000 |
| P-16 | 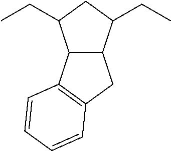 | 95 | 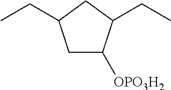 | 5 | 29000 |
| P-17 | 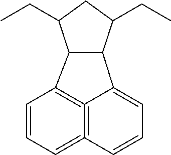 | 88 | 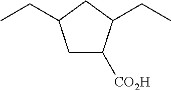 | 12 | 33000 |
| P-18 | 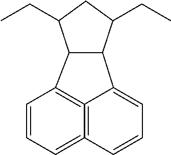 | 90 | 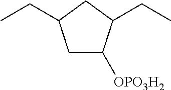 | 10 | 28000 |
| P-19 | 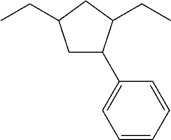 | 85 | 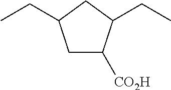 | 15 | 35000 |
| P-20 | 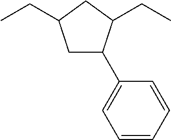 | 93 | 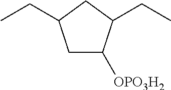 | 7 | 36000 |

The block copolymer is synthesized utilizing living radical polymerization and living ion polymerization, and techniques to protect carboxyl group or introduce a functional group to a polymer as necessary. It is also possible to synthesize the block copolymer by radical polymerization of polymers having terminal functional groups, and formation of bonds between polymers having terminal functional groups. In particular, it is preferable to utilize living radical polymerization and living ion polymerization in view of molecular weight control and yield of block copolymer. Production methods of the block copolymer are described in, for example, “Synthesis and reaction of polymer (1)” edited by The Society of Polymer Science, Japan, and published by Kyoritsu Shuppan, Co., Ltd. (1992), “Precision polymerization” edited by Chemical Society of Japan, and published by Japan Scientific Societies Press (1993), “Synthesis reaction of polymer (1)” edited by The Society of Polymer Science, Japan, and published by Kyoritsu Shuppan Co., Ltd. (1995), ‘Telechelic Polymer: Synthesis, Characterization, and Applications’ by R. Jerome, et al. in pages 837 to 906 of “Progress in Polymer Science”, Vol. 16 (1991), ‘Light-induced synthesis of block and graft copolymers’ by Y. Yagci et al, in pages 551 to 601 of “Progress in Polymer Science”, Vol. 15 (1990), and U.S. Pat. No. 5,085,698.

One kind or a mixture of two or more kinds of the above-described block copolymers may be used.

[Inorganic Fine Particles]

The inorganic fine particles (inorganic nanoparticles) used in the invention include, for example, oxide fine particles and sulfide fine particles, more specifically, zirconium oxide fine particles, zinc oxide fine particles, titanium oxide fine particles, tin oxide fine particles, and zinc sulfide fine particles. However, the inorganic fine particles are not limited to those. Of those, metal oxide fine particles are especially preferable. In particular, one selected from the group consists of zirconium oxide fine particles, zinc oxide fine particles, tin oxide fine particles and titanium oxide fine particles is preferable, and one selected from the group consists of zirconium oxide fine particles, zinc oxide fine particles, and titanium oxide fine particles is more preferable. Furthermore, it is especially preferable to use zirconium oxide fine particles with low photocatalytic activity and excellent transparency in the visible light region. In the invention, a dispersion of two or more kinds of the above inorganic fine particles may be used in view of refractive index, transparency, and stability. To meet purposes such as reducing photocatalytic activity and a water absorption ratio, the above inorganic fine particles may be doped with different kinds of elements, and surfaces of the inorganic fine particles may be covered with dissimilar metal oxide such as silica and alumina. It is also possible that the inorganic fine particles are surface-modified with silane coupling agent, titanate coupling agent or the like.

Production methods of inorganic fine particles used in the invention are not particularly limited, and any well-known method can be used. For example, desired fine oxide particles are produced using metal halide or metal alkoxide as a raw material, and hydrolyzing the raw material in a reaction system containing water.

Specifically, following methods to prepare zirconium oxide fine particles and its suspension are known, and any of them may be used: a method to prepare zirconium oxide suspension in which a solution containing zirconium salt is neutralized by an alkali to obtain zirconium hydrate, and the obtained zirconium hydrate is dried and sintered and then dispersed in a solvent; a method to prepare zirconium oxide suspension in which a solution containing zirconium salt is hydrolyzed; a method in which zirconium oxide suspension is prepared by hydrolysis of a solution containing zirconium salt and then the prepared zirconium oxide suspension is ultrafiltered to obtain zirconium oxide; a method to prepare zirconium oxide suspension by hydrolysis of zirconium alkoxide; and a method to prepare zirconium oxide suspension by heating and applying pressure to a solution containing zirconium salt under hydrothermal condition.

Titanyl sulfate is exemplified as a raw material for the synthesis of titanium oxide fine particles. Zinc salts such as zinc acetate and zinc nitrate are exemplified as raw materials for the synthesis of zinc oxide fine particles. Metal alkoxides such as tetraethoxysilane and titanium tetraisopropoxide are also suitable for raw materials of inorganic fine particles. The synthetic methods of such inorganic fine particles include, for example, a method described in pages 4603 to 4608 of Japanese Journal of Applied Physics, vol. 37 (1998), and pages 241 to 246 of Langmuir, vol. 16, issue 1 (2000).

In particular, where oxide fine particles are synthesized by a sol formation method, it is possible to use a procedure of forming a precursor such as a hydroxide, and then dehydrocondensing or peptizing the same with an acid or an alkali, and thereby forming a hydrosol, as in the synthesis of titanium oxide fine particles using titanyl sulfate as a raw material. In such a procedure, it is appropriate that the precursor is isolated and purified by any known method such as filtration and centrifugal separation in view of purity of a final product. The sol particles in the obtained hydrosol may be insolubilized in water and isolated by adding an appropriate surfactant such as sodium dodecylbenzene sulfonate (abbreviated DBS) or dialkylsulfosuccinate monosodium salt (a product of Sanyo Chemical Industries, Ltd., trade name “ELEMINOL JS-2”) to the hydrosol. For example, the well-known method described in pages 305 to 308 of “Color Material”, vol. 57, 6, (1984) can be used.

In addition to the above-described hydrolysis in water, a method of preparing inorganic fine particles in an organic solvent can be exemplified. In this case, the thermoplastic polymer used in the invention may be dissolved in the organic solvent.

Examples of the solvent used in the above-mentioned methods include acetone, 2-butanone, dichloromethane, chloroform, toluene, ethyl acetate, cyclohexanone and anisole. One kind or a mixture of two or more kinds of the solvents may be used.

Where the number average particle size (diameter) of the inorganic fine particles used in the invention is too small, intrinsic properties of the inorganic material forming the fine particles may not be exerted, and on the other hand, where it is too large, the impact of Rayleigh scattering becomes significant, reducing transparency of the organic-inorganic hybrid material drastically. Therefore, the lower limit of the number average particle size of the inorganic fine particles used in the invention is preferably at least 1 nm, more preferably at least 2 nm, and furthermore preferably at least 3 nm, and the upper limit thereof is preferably at most 15 nm, more preferably at most 10 nm, and furthermore preferably at most 7 nm. Namely, the number average particle size of the inorganic fine particles used in the invention is preferably from 1 nm to 15 nm, more preferably 2 nm to 10 nm and furthermore preferably from 3 nm to 7 nm.

The “number average particle size” used herein is measured using, for example, an X ray diffraction (XRD) device or a transmission electron microscope (TEM).

A refractive index of the inorganic fine particles used in the invention is preferably in a range of 1.9 to 3.0 at the wavelength of 589 nm at 22° C., and more preferably in a range of 2.0 to 2.7, and especially preferably in a range of 2.1 to 2.5. Where the refractive index of the inorganic fine particles is at most 3.0, Rayleigh scattering is suppressed since a difference in refractive indices between the inorganic fine particles and the thermoplastic polymer is not so large. Where the refractive index of the inorganic fine particles is at least 1.9, a produced optical lens achieves a high refractive index.

The refractive index of the inorganic fine particles is obtained by, for example, measuring the refractive index of a transparent film made of an organic-inorganic hybrid material containing the inorganic fine particles and the thermoplastic polymer used in the invention with Abbe's refractometer (for example, a product of Atago, model: DM-M4), and converting the measured value using a refractive index of the thermoplastic polymer component separately measured. It is also possible to calculate the refractive index of the inorganic fine particles by measuring refractive indices of inorganic fine particle dispersions having different concentrations.

The content of inorganic fine particles in an organic-inorganic hybrid material of the invention is preferably 20 mass % to 95 mass %, and more preferably 25 mass % to 70 mass %, and especially preferably 30 mass % to 60 mass % in view of transparency and achieving a high refractive index. In the invention, a mass ratio between the inorganic fine particles and thermoplastic polymer (dispersion polymer) is preferably 1:0.01 to 1:100, and more preferably 1:0.05 to 1:10, and especially preferably 1:0.05 to 1:5 in view of dispersibility.

The above-described organic-inorganic hybrid material (nanocomposite material) contains inorganic fine particles and thermoplastic polymer having a functional group, in a main chain end or a side chain, capable of forming any kind of chemical bond with the inorganic fine particles. Such nanocomposite material is effectively utilized as a raw material for an optical lens, and injection molded or press molded using a mold having a spherical or nonspherical surface. The combined use of the produced optical lens, a plastic lens, and a glass lens is effective as an optical component for various optical-system units. The optical-system unit including the optical lens made of the above-described nanocomposite material is described in the following.

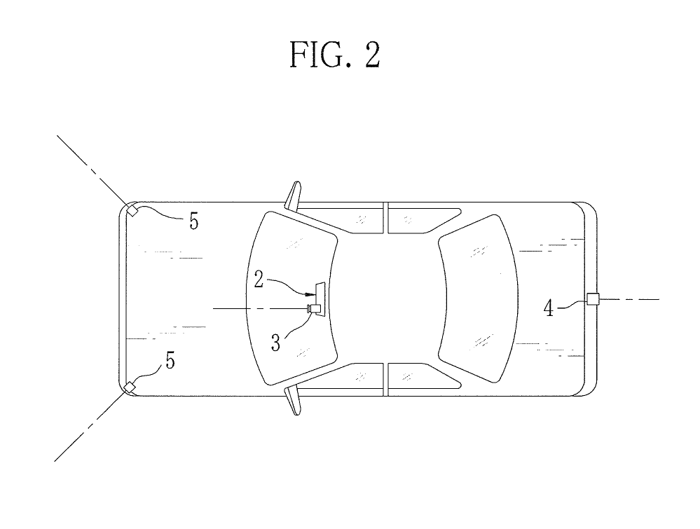

An optical system unit including the optical lens of the invention can be used as a taking optical system 3 of an imaging apparatus, for example, a vehicle-mounted surveillance camera 2 as shown in FIG. 2. The surveillance camera 2 is used for assisting safe driving. During driving, the surveillance camera 2 takes an image of a wide area ahead of the vehicle to monitor other vehicles and the like approaching from the front or the sides thereof, and the vehicle may give an alarm or automatically stop as necessary. It is also effective to use the surveillance camera 2 in combination with surveillance cameras 4 and 5 which monitor areas to the sides and the rear of the vehicle.

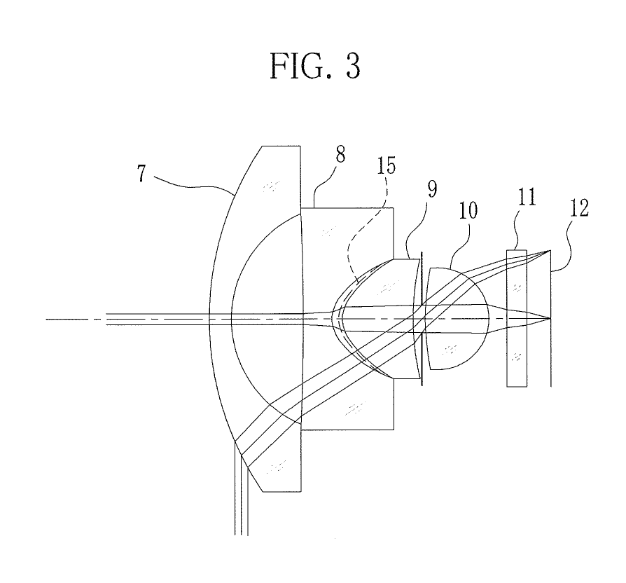

In FIG. 3, a first lens 7 is a glass lens made of optical glass. A second lens 8 and a fourth lens 10 are conventional plastic lenses made of resin. A third lens 9 is a plastic optical lens made of the above described nanocomposite material. Light passes through the first, second, third, and fourth lenses 7, 8, 9 and 10, and a cover glass 11, and forms a subject image on a photoelectric surface 12 of an imaging element such as a CCD image sensor. The cover glass 11 protects the photoelectric surface 12.

An optical-system unit for use in imaging, in particular, the optical-system unit incorporated in a vehicle-mounted surveillance camera or an outside surveillance camera is apt to be exposed to UV rays. Therefore, it is necessary to prevent exposure of the optical-system unit to UV rays where a part of the optical-system unit includes an optical lens made of the nanocomposite material of the invention, and the nanocomposite material contains the inorganic fine particles such as titanium oxide or a semiconductor element whose optical properties deteriorate on exposure to UV rays.

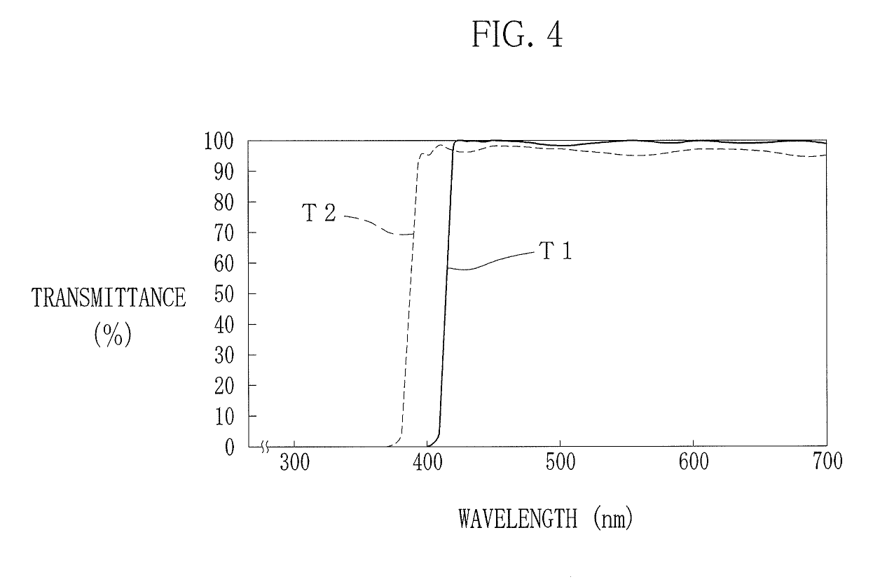

Accordingly, a thin film layer 15 is formed on a light incident surface of the third lens 9 as schematically shown in broken lines in FIG. 3. The thin film layer 15 is composed of a multilayer interference film having, for example, a total of 32 alternating layers of a TiO₂ film and an SiO₂ film. The spectral transmittance T1 of the thin film layer 15 is shown in a solid line in FIG. 4. Such thin film layer 15 is formed on the light incident surface of the third lens 9 using a well known method such as vacuum vapor deposition, IAD (ion assisted deposition), spattering, ion plating, PVD, or CVD. As shown by the spectral transmittance T1, the thin film layer 15 transmits at most 10% of UV rays at the wavelength of 420 nm, and hardly transmits light in UV region with the wavelength of less than 420 nm. Thus, light entering the third lens 9 hardly contains UV rays. Accordingly, deterioration of the optical transmittance of the inorganic particles contained in the nanocomposite material is prevented.

The spectral transmittance shown in FIG. 4 is determined by the refractive index of the material of the thin film layer 15 and the number of layers in the thin film layer 15, and production cost also depends on the selection of the material and the number of layers. For example, spectral transmittance T2 shown in broken lines in FIG. 4 depicts the spectral transmittance of the thin film layer 15 with a total of 17 alternating layers of a TiO₂ film and an SiO₂ film, and indicates that the thin film layer 15 transmits at most 10% of UV rays at 370 nm wavelength, and hardly transmits light at the wavelength of less than 370 nm. The thin film layer 15 with such spectral transmittance T2 is also practical without any problems. A film configuration of the thin film layer 15 is selected as appropriate in consideration of production cost.

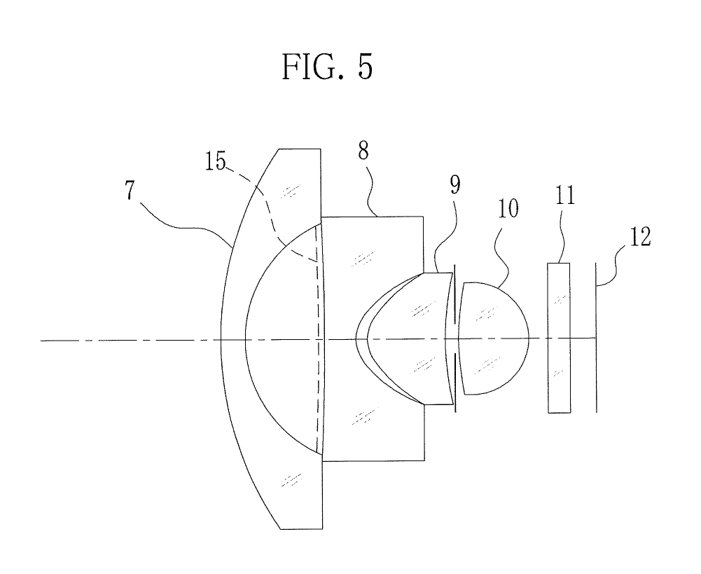

FIG. 5 shows an example in which the above described thin film layer 15 is applied to the light incident surface of the second lens 8, an optical component placed on the light incident side from the third lens 9. Thus, it is also possible to prevent deterioration of the inorganic fine particles contained in the third lens 9 by coating the thin film layer 15 onto an optical component such as a lens or a lens-protecting cover plate (a plane parallel plate) placed on the light incident side from the third lens 9.

The first lens 7 is made of optical glass. Not a few kinds of the optical glass absorb UV rays. In particular, lanthanum glass, which achieves an especially high refractive index, has a color degree as high as 40/35. The first lens 7 made of such optical glass absorbs most of UV rays, and thus the UV rays which reach the third lens 7 are reduced. For example, internal transmittance of optical glass having the color degree of 40/35 and a refractive index of 1.75 at 350 nm UV wavelength is calculated as follows. An interface reflectivity of an interface between air and the optical glass is 7.4% where the optical glass has the refractive index of 1.75 and the thickness of 2 mm.

{0.05/(1−0.074)²}^{2/10}=0.566

Thus, the amount of light at 350 nm wavelength transmitting through the optical glass is reduced by approximately half. The color degree “40/35” denotes that a sample with the thickness of 10 mm has spectral transmittance of 80% at 400 nm wavelength, and 5% at 350 nm wavelength. 400 nm and 350 nm are round off numbers obtained by rounding off the actual numbers to the nearest ten, and two digits of ten and hundred are expressed as 40/35. Therefore, a lens and a plane parallel plate made of optical glass with the color degree of a lower UV transmittance than the optical glass with the color degree of 40/35 can be used as the UV blocking element of the invention.

The lens configuration of the optical system unit is not limited to the above-described examples illustrated in the figures. For example, it is also possible to configure the optical system unit with two or more optical lenses made of the nanocomposite materials of the invention. Additionally, the application of the optical system unit is not limited to the surveillance camera. The optical system unit can be widely used in various imaging apparatuses such as ordinary digital cameras and digital cameras incorporated in mobile phones.

### INDUSTRIAL APPLICABILITY

The present invention is preferably applied to an optical lens, and various optical lens systems and imaging apparatuses using the same, such as a digital camera and a surveillance camera.

1. An optical lens comprising:
an organic-inorganic hybrid material containing inorganic fine particles and a thermoplastic polymer having a functional group in at least one of a main chain end and a side chain, said functional group forming a chemical bond with at least one of said inorganic fine particles; and
a UV blocking element provided on a light incident surface for limiting passage of UV rays.

2. The optical lens of claim 1, wherein said UV blocking element is a thin film coated on said light incident surface of said optical lens.

3. The optical lens of claim 1, wherein said UV blocking element has UV transmittance of at most 10% at a wavelength of at most 420 nm.

4. The optical lens of claim 1, wherein said UV blocking element has UV transmittance of at most 10% at a wavelength of at most 370 nm.

5. An optical system unit comprising:
an optical lens made of an organic-inorganic hybrid material containing inorganic fine particles and a thermoplastic polymer having a functional group in at least one of a main chain end and a side chain, said functional group forming a chemical bond with at least one of said inorganic fine particles; and
a UV blocking element provided forward of and on a light incident side from said optical lens for blocking passage of UV rays.

6. The optical system unit of claim 5, wherein said UV blocking element is a thin film coated on a surface of an optical component placed forward of and on said light incident side from said optical lens.

7. The optical system unit of claim 5, wherein said UV blocking element is an optical component containing a material which absorbs UV rays, and said UV blocking element is placed forward of and on said light incident side from said optical lens.

8. The optical system unit of claim 5, wherein said UV blocking element has UV transmittance of at most 10% at a wavelength of at most 420 nm.

9. The optical system unit of claim 5, wherein said UV blocking element has UV transmittance of at most 10% at a wavelength of at most 370 nm.

10. An imaging apparatus comprising:
an optical lens having an organic-inorganic hybrid material containing inorganic fine particles and a thermoplastic polymer having a functional group in at least one of a main chain end and a side chain, and a UV blocking element provided on a light incident surface for limiting passage of UV rays, said functional group forming a chemical bond with at least one of said inorganic fine particles.

11. An imaging apparatus comprising:
an optical system unit including an optical lens made of an organic-inorganic hybrid material containing inorganic fine particles and a thermoplastic polymer having a functional group in at least one of a main chain end and a side chain, and a UV blocking element provided forward of and on a light incident side from said optical lens for blocking passage of UV rays, said functional group forming a chemical bond with at least one of said inorganic fine particles.
